(19) United States
(12) Patent Application Publication
(10) Pub. No.: US 2013/0080196 A1
(43) Pub. Date: Mar. 28, 2013

(54) Computer-Aided Mobility Service

(71) Applicants: Astrid SCHROEDER, Muenchen (DE); Heleen Borghols-Wilmink, Isen (DE); Marco Eggert, Lippstadt (DE)

(72) Inventors: Astrid SCHROEDER, Muenchen (DE); Heleen Borghols-Wilmink, Isen (DE); Marco Eggert, Lippstadt (DE)

(73) Assignee: Bayerische Motoren Werke Aktiengesellschaft, Muenchen (DE)

(21) Appl. No.: 13/566,126

(22) Filed: Aug. 3, 2012

(30) Foreign Application Priority Data
Aug. 5, 2011 (DE) 10 2011 080 554.0

(51) Int. Cl. G06Q 10/02

(52) U.S. Cl. CPC G06Q 10/02
USPC 705/5

(57) ABSTRACT

A process is provided for computer-aided operation of a mobility service by which a number of vehicles are made available by a mobility provider to registered users for temporary use. A respective user is registered once in a booking system as a provider and/or a buyer of a mobility service feature. A first user registered as a provider reserves the vehicle for a period of time in the booking system. The first user further clears the use of a mobility service feature for a second user connected with the vehicle booking whereby the mobility service feature for the second user is offered for selection. An accounting of costs for the vehicle booking takes place as a function of whether at least one second user was determined as a buyer of the provided mobility service feature.

### CROSS REFERENCE TO RELATED APPLICATION

This application claims priority under 35 U.S.C. §119 from German Patent Application No. 10 2011 080 554.0, filed Aug. 5 2011, the entire disclosure of which is herein expressly incorporated by reference.

### BACKGROUND AND SUMMARY OF THE INVENTION

The invention relates to a process for the computer-aided operation of a mobility service by which a number of vehicles are made available by a mobility provider to registered users for temporary use. The invention also relates to a booking system for a mobility service.

Ride-sharing is an organized taking-along of fellow travelers which makes traveling less expensive for several persons that form together as a carpool. Such carpools are organized mainly by way of carpooling centers which, as a rule, connect these carpools for a charge or free-of-charge. Currently, there are carpooling centers with different emphases—for one-time-oriented long distances to regular commuter routes with a subdivision-focused search of surroundings or other spontaneous “on the go” connections made by smartphone or an internet-compatible navigation system.

A vehicle leasing system (so-called car sharing) is the organized joint use of one or more vehicles. The vehicles of a car sharing organization are usually distributed on fixedly rented parking lots in a city or moderately sized community. The sites are frequently located at points of intersection of public transport (such as train stations, end stations of bus lines, etc.), where they are easily reachable by members of the car sharing organization. The vehicles, which are reserved ahead of time, are mostly used for also reaching destinations situated away from these points of intersection of public transport. In contrast to classic car rentals, vehicles can also be used for a short time, for example, by the hour.

It is an object of the present invention to provide an improved mobility service, which results in a reduction of individual transport and therefore consumes fewer resources.

This and other objects are achieved by a process for the computer-aided operation of a mobility service by which a number of vehicles are made available by a mobility provider to registered users for temporary use. A respective user is registered once in a booking system as a provider of a mobility service feature and/or as a buyer of a mobility service feature in that, based on a user input, registration data of the user are acquired and stored. A vehicle booking is carried out in that, based on a user input of a first user registered as a provider of a mobility service feature, the vehicle is reserved for the period of time in the booking system, the user input comprising a time period and a desired vehicle. As a function of a further user input of the first user, the use of a mobility service feature for the second user connected with the vehicle booking is cleared, whereby, in the booking system, the mobility service feature for the second user is offered for selection by way of user interfaces. An accounting of the costs for providing the vehicle in the time period with respect to the first user takes place as a function of whether, by way of the booking system, at least one second user was determined as the buyer of the provided mobility service feature, the costs for the first user decreasing as a function of the number of second users using the mobility service feature. A booking system is also provided to implement the process.

The invention provides a process for the computer-aided operation of a mobility service by which a number of vehicles are made available by a mobility provider to registered users for temporary use. The term “vehicles” includes motor vehicles having an internal-combustion engine and/or an electric motor, as well as other means of transportation suitable for individual transport.

A respective user is registered once in a booking system as a provider of a mobility service feature and/or as a buyer of a mobility service feature in that, based on a user input, registration data of the user are acquired and stored. Only a person who is in possession of a valid driver's license can be a provider of a mobility service feature. This is preferably checked during the registration. Within the scope of the present invention, the drivers of a temporarily rented vehicle are therefore providers. In contrast, buyers of a mobility service feature are front seat passengers or fellow passengers in a vehicle. These may be persons who are in possession of a valid driver's license and, within the scope of another mobility service, may also operate as providers. Likewise, buyers may be persons without a driver's license.

Within the scope of the present description, a mobility service feature is a drive connected with a certain activity by means of a vehicle made available by a mobility provider to a destination (for example, a shopping destination, a leisure destination (amusement park, swimming pool, opera, movie theater, etc.), a location (city, city district, a starting point for a leisure activity, etc.), and the like). A mobility service feature is therefore primarily (but not exclusively) defined by the activity taking place at the destination of the drive. A drive that is not time- or location-specific can therefore be provided as an activity in the future. This may therefore, for example, be a stroll with a dog in the nature park close to a city. A person can thereby find other dog lovers who would also like to go for a stroll on the outskirts of the city.

The following steps can be implemented with arbitrary frequency compared with the one-time registration step.

A vehicle booking is carried out in that, based on a user input of a first user registered as a provider of a mobility service feature, the vehicle is reserved for the time period in the booking system, the user input comprising a time period and a desired vehicle. This step therefore comprises the renting of vehicles of a mobility provider or also of private vehicles for temporary use, as known from car sharing. The renting can be carried out only by those registered users of the mobility service who have a driver's license; i.e. the first user always has to be registered as a provider.

As a function of a further user input of the first user, the use of a mobility service feature for the second user connected with the vehicle booking is cleared, whereby, in the booking system, the mobility service feature for the second user is offered for selection by way of user interfaces. According to this step, it is up to the first user whether or not he wants to “invite” fellow passengers to the activity planned by him. In the event that he wants to give fellow passengers the opportunity to participate in the activity, he will clear the offered mobility service feature by way of a user interface (for example, PC, laptop, Smartpone, etc.) (“clear the drive”). As a reaction thereto, the booking system makes available the offered mobility service feature for selection by the other users of the mobility service feature by way of a user interface. If a second user selects the provided mobility service feature, he becomes the fellow passenger of the mobility service feature. Within the scope of the present description, the step of selecting comprises the complete operation of the obligatory booking. The details of the implementation are not relevant to the invention.

Furthermore, an accounting of the costs for providing the vehicle in the time period with respect to the first user takes place as a function of whether, by use of the booking system, at least one second user was determined as the buyer of the provided mobility service feature. The costs for the first user decrease as a function of the number of second users using the mobility service feature. The provider of the mobility service feature, who is simultaneously the renter of the vehicle with respect to the mobility provider, has to pay the latter, which may be based on time and/or dependent on mileage. The accounting could, for example, take place by way of a price per minute. If at least one second user can be found by way of the booking system, the payment to be made by the driver will be reduced. The reduction may be the larger, the more fellow passengers are registered by way of the booking system. The charge model can be selected such that, for example, —depending on the vehicle—, the driver does not have to make any more payments to the mobility provider when a certain number of passengers is reached. This makes it more attractive for the first user (driver) to search for passengers, which results in the reduction of individual transport costs. Irrespective thereof, second users, who register by way of the booking system for the provided mobility service feature, each have to pay the mobility provider. This may be graded corresponding to the number of fellow passengers. The same amount or a different amount may be charged for all passengers. Preferably, a payment is charged to the second users (passengers) which—analogous to the first user—in a time-based and/or mileage-dependent manner. The charging takes place in an automated fashion by way of the booking system.

The invention results in a process which connects ride sharing with the principles of car sharing and an event/leisure exchange. In this case, the providing of ride sharing is based on a mobility service feature.

This results in a number of advantages. Even persons without a driver's license can now participate in car sharing or individual transport. This is important, for example, for an aging population who no longer want to drive or who can drive themselves but require door-to-door transport. The ride sharing is not only limited to long-distance routes, as previously. Ride sharing is also made possible for short distances and within communities, which can be controlled particularly by the rate model of the mobility provider. Individual transport can be reduced in this manner, whereby resources can be saved and CO₂ emissions reduced. By taking along passengers, the fee for the drive will be reduced for the driver (vehicle renter). It is possible to become acquainted with persons with similar destinations or interests. This increases the motivation to participate in the service as a driver or passenger, because advantages may arise, such as loading/unloading assistance by the passenger after a drive to a home improvement retailer.

In an advantageous further development of the process, a selection of the mobility service feature is carried out by the second user in that, based on a user input, one or more activity categories are selected to which the mobility service feature applies or apply. As explained above, this is based on the circumstance that the mobility service feature offered by the first user represents a drive connected with a certain activity. In contrast to conventional ride sharing, this increases the flexibility of use and provides a higher acceptance, which result in greater utilization with a reduced consumption of resources.

In a further advantageous development of the process, a classification of the mobility service feature into activity categories is carried out by the first user in that, based on a user input, one or more predefined and/or self-established activity categories are assigned to the mobility service feature. This permits a structured search for mobility service features of many different types in the booking system, increasing the attractiveness for users.

In a further advantageous development of the process, a charging of the costs for providing the vehicle in the time period with respect to the second user takes place as a function of whether at least one additional second user was determined as a buyer of the offered mobility service feature by way of the booking system on the initiative of the second user, in which case the costs are decreased for the first user and the second user as a function of the number of additional second users using the mobility service. The determination of an additional second user, i.e. at least one third passenger, can take place, for example, by sending an invitation message of that second user who already is a passenger to an additional second user. If the latter registers for the mobility service feature, the receipt of the invitation message is determined during his booking by the booking system, so that the cost reduction is credited to the “soliciting” fellow passenger. The amount to be paid by fellow passengers is lower than the amount a driver would have to pay were he to drive alone. This increases the readiness to become a “fellow passenger”, which reduces individual transport. Furthermore, passengers can invite other passengers to a drive and thereby further reduce their costs. This increases the readiness to be the “first” passenger and to rapidly fill the vehicles.

In a further advantageous development of the process, a message is generated in an automated manner by the booking system and is transmitted to a drive destination of the mobility service feature, the message containing information concerning the number of users registered for the mobility service feature. The destination of the drive may, for example, be a shopping destination (individual business, outlet center, shopping center, etc.), a leisure destination (amusement park, swimming pool, opera, movie theater, etc.) or the destination of an excursion. It is understood that the transmission of the message takes place to a correspondingly equipped computer of the drive destination.

In a further advantageous development, the drive destination of the mobility service feature (i.e. its computer) generates a message in an automated manner, which is offered as a reaction to a mobility service feature offered by the first user and transmits the latter to the booking system. In the message, a bonus is offered to the buyers (i.e. those users who already are passengers) and potential users (thus, those who could still become passengers) of the mobility service feature. The bonus (comprising the bonus as such as well as the type and nature of the bonus) is offered optionally as a function of the number of registered users. Discounts of businesses of the shopping destination, for example, may thereby be announced to the first and second users of the vehicle, who, for example, are (or will be) headed for a shopping destination, because a car pool requires fewer parking spaces than individually traveling persons. This promotes the goal of saving resources. The more interesting the (announced) bonus to the user, and if this bonus is issued, for example, only when a minimal number of users has been reached, the greater the incentive of traveling with as many users as possible jointly in one vehicle to the destination of the drive. This furthers the effort of obtaining passengers for the first user as well as the second user.

The bonuses may also be offered, independently of a preceding message concerning the number of users, by a business (businesses can establish new categories and register their business there as a destination in the booking system) if the automobile is “full”. As soon as the booking system registers a full trip to one of these destinations, the driver can print out and take along a bonus coupon of the business.

In a further advantageous development, a point value is credited to the providers and/or buyers of a mobility service feature for each use of the mobility service feature as a function of the number and/or type of the mobility service feature and/or the number of buyers to their respective user account. A bonus system is thereby achieved which promotes the motivation to participate in the process with the above-described positive effects. For the first user, the bonus may, for example, consist of applying the points to the costs for using a vehicle rented in the future. When a certain point level has been reached, the renting of a vehicle could then be free-of-charge for a certain time period. Likewise, a higher vehicle class could be promised without any surcharge. Naturally, the bonus may also be designed differently and comprise, for example, bonuses in kind.

In a further advantageous development of the process, of the first users, that first user is represented by way of the user interfaces who has most frequently provided one or more mobility service features within a predefined time period. Users may, for example, receive so-called “badges” which other users can inspect by way of the booking system. These are decorations, which “honor” the recipient of a badge, for example, for carrying out the most drives to an activity destination within a month.

In a further advantageous development of the process, a drive destination for a mobility service feature is entered by third parties into the booking system, based on a user input of the third party by way of a user interface. Businesses, (for example, shops, restaurants, leisure parks, movie theaters, etc.) will thereby be given the opportunity to utilize the booking system as an advertising platform. They may possibly pay a fee to the provider of the booking system for this purpose. In this further development, a first user then has to file such a drive destination for his mobility service feature in the booking system.

In a further advantageous development of the process, the booking system automatically generates a message and transmits the message to a user interface of the second user. This message comprises information concerning an offered and/or a no longer available mobility service feature if notification information for the second user is stored in the booking system. This further development developed as a notification service permits, for example, a booking of a mobility service feature at short notice (“spontaneous boarding”) if the message is transmitted to mobile devices of potential second users. In this case, it is even possible to board a drive that has already started, perhaps if the boarding user can be picked up along a planned driving route. A message automatically generated by the booking system will preferably be generated as soon as a mobility service feature is newly available. It is preferably also generated when all seats of a vehicle are already occupied and the mobility service feature can therefore not be offered to additional users. As a search filter, potential second users can select and store, for example, an activity category in the booking system.

In a further advantageous development of the process, during the one-time registration of a user and the boarding of the vehicle, biometric data, such as a finger print, and/or one-to-one security information of the user is determined and mutually compared. This development variant permits the integration of a security feature. The security information can, for example, be contained in a so-called “secure token” (token) which users obtain for payment or free-of-charge from the mobility provider. The users can identify themselves, for example, to fellow passengers by means of the token. The security information/the token can also be used for the settlement of accounts which, on the one hand, permits automatic handling and, on the other hand, makes it secure.

Furthermore, the token can be used for other functions described above. It can therefore also be used for the spontaneous booking onto drives (“boarding along the route”).

The invention further creates a booking system for carrying out the process described above.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1 to 6 are schematic views, respectively, of individual steps of the process sequence according to an embodiment of the invention by way of information illustrated on a display of a mobile communications device from the view of a provider and buyer of a mobility service feature.

### DETAILED DESCRIPTION OF THE DRAWINGS

The process permits the providing, finding and booking of drives which relate to certain activities. In contrast to known ride sharing, the drives that represent a mobility service feature are not carried out by private vehicles but rather by use of vehicles provided by a mobility provider for temporary rentals. The mobility provider, such as a vehicle manufacturer or a vehicle rental firm, provides, for example, stations with vehicles for this purpose. Likewise, the vehicles can be parked “free-of-charge” in certain parking space areas, for example, somewhere on the side of the road. Preferably, vehicles of different sizes and classes are provided for making it possible for the participants to carry out many different activities.

In an alternative development, the vehicles could also be made available by private parties.

The mobility provider or another service provider provides the infrastructure for a booking system, which permits the registration and management of the users, the booking, the procuring, and the settling of accounts of the drives. Optionally, the booking system may also offer a discussion of drives. The booking system is accessible, for example, by way of the user interface of a PC, a laptop, a tablet PC, a smartphone, a telephone, or the like.

The users first have to register once as members and can then log into the booking system. Within the scope of the registration, the operator of the booking system will carry out a secure examination of the users, which includes specifically security information that is unambiguous for the user. Likewise, biometric characteristics, for example, a fingerprint, can be acquired. A monthly fee (membership fee) is optionally charged for the registration.

Each user has to indicate whether he wants to be a provider or buyer of a mobility service feature (or both). A provider of a mobility service feature can only be a person who is in possession of a valid driver's license. This is checked during the registration. Drivers of a temporarily rented vehicle represent providers. In contrast, buyers of a mobility service feature are the front seat passenger or a fellow passenger in a vehicle. These may be persons who are in possession of a valid driver's license and may also act as providers within the scope of another mobility service feature. Likewise, buyers may be persons without a driver's license. The provided mobility service feature can therefore also be utilized by persons without a driver's license.

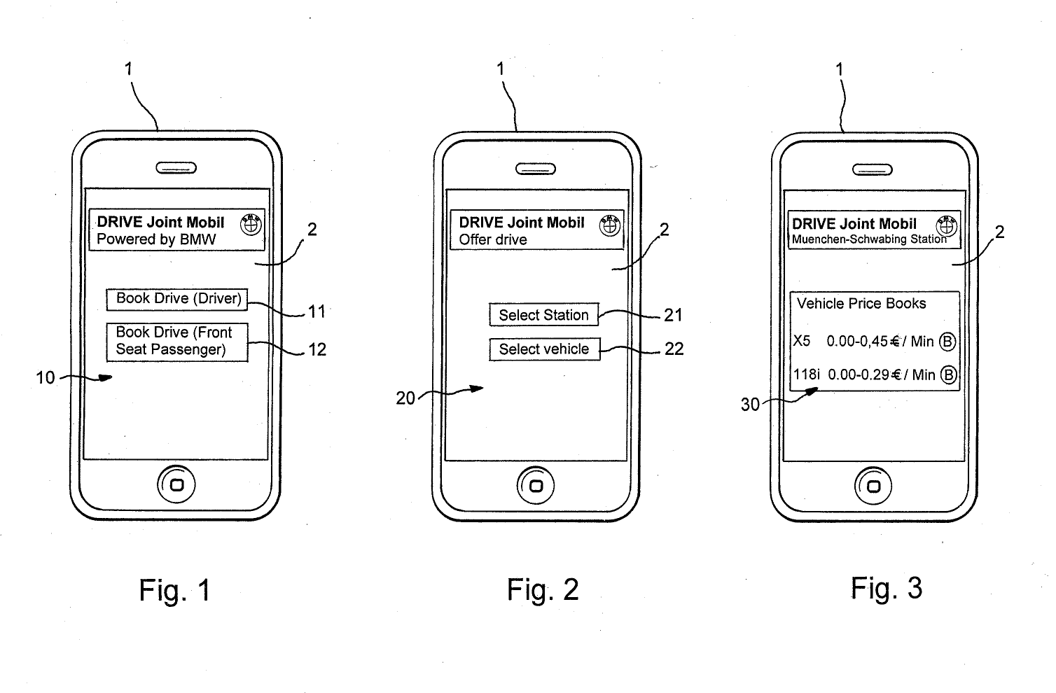

After logging into the booking system, a user, who wants to use the mobility service, first has to indicate whether he wants to be the provider (driver) or buyer (front seat passenger or fellow passenger) of a drive. In the examples described in the following, a mobile terminal 1 having a touch-sensitive display 2 is used as an input and output device. Reference number 10 in FIG. 1 illustrates the video screen display 10 relevant to the decision that is to be made by the user. Here the driver is given the opportunity to become the driver 11 (“book drive (driver)”) or the fellow passenger 12 (“book drive (front seat passenger)”).

As a driver, the user (provider) actively offers drives in certain categories. Categories may, for example, be a drive to a furniture store, hiking, a children's excursion, an excursion for seniors, a visit to a disco, etc. In the next step (FIG. 2), the driver indicates from which station of the mobility provider the drive is to start. In the video screen display marked 20, the driver selects “select station” (reference number 21) for this purpose. Here, he can, for example, select a station from a list which may simultaneously represent the starting point for the drive. The driver further selects a vehicle to be used for the drive (“select vehicle” (reference number 22)). If a drive is to take place, for example, to a furniture store or a home improvement retailer, a large vehicle will advantageously be selected. In contrast, a small or smaller vehicle will be selected for a visit to a disco.

FIG. 3 illustrates the video screen 30. Here, video screen 30 (as well as video screens 50 and 60 in FIGS. 5 and 6) is shown merely for purposes of indicating an area on which information may be provided. The undecipherable text in the Figures can take any form consistent with the description herein and as such its actual content is not shown. The video screen 30 can be used to indicate to the driver the costs per minute for the available vehicles (or a rate consisting of a time-related rate and a flat rate per kilometer). As an example, a BMW X5 and a BMW 118i may be available here. For informing the driver, a minimal and a maximal price is assigned to each of the vehicles. The actually charged price depends on the number of passengers. If no passenger participates in the drive (either because this is not desired by the driver or no passenger can be found), the maximal price will be valid. Under the most favorable circumstances, the minimal price will apply which, if a vehicle is full, may even amount to zero. On this video screen, the driver carries out the selection and the booking of the vehicle.

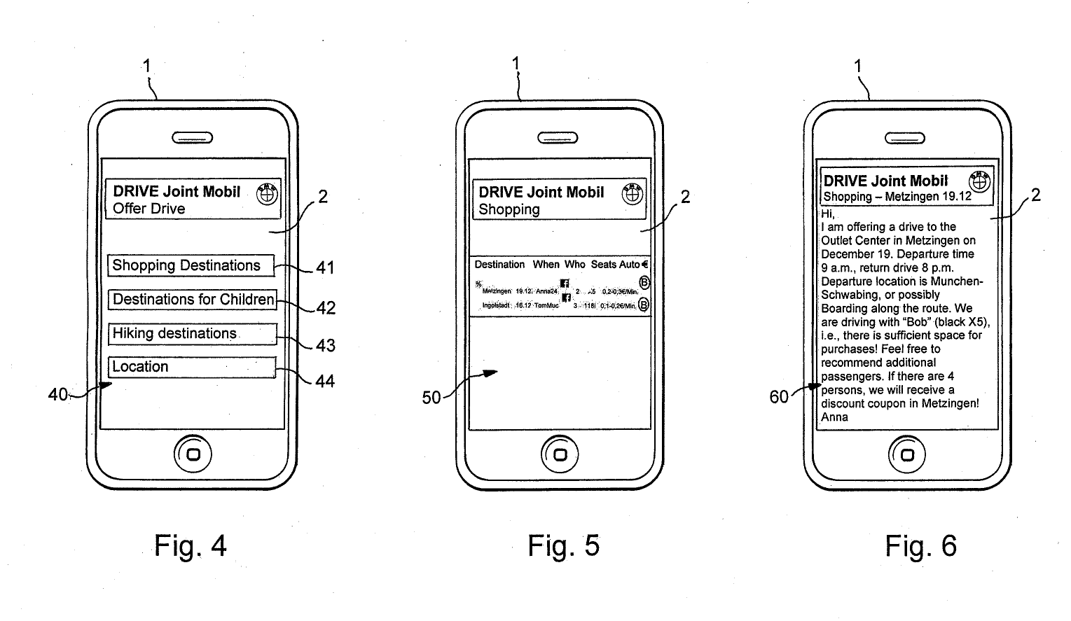

When a user registers as a front seat passenger, he can search for offered drives in the categories offered by the booking system. This is illustrated, for example, in FIG. 4. For example, the video screen marked 40 offers the categories “shopping destinations” (41), “destinations for children” (42), “hiking destinations” (43), and “locations” (44). The user searching for a drive selects “shopping destinations”. As illustrated in FIG. 5, the cities “Metzingen” and “Ingolstadt” are offered to him. In addition to information as to when drives will be taking place (“when”) and who is offering these drives (“who”), information concerning vacant seats (“seats”), the vehicle made available by the provider (“auto”), as well as information concerning the fare (“ [symbol] ”) per minute are displayed. It is clear to a person skilled in the art that the charging could also take place according to other criteria. Here also, a minimal and a maximal price are indicated. The actually charged price depends, for example, on the number of fellow passengers or the number of passengers solicited by a fellow passenger. If no additional passenger goes along for the drive (for example, because no additional passenger is found), the maximal price will apply. Under the most favorable circumstances, i.e. the soliciting of a maximal number of passengers, the minimal price will apply. On this video screen the passenger carries out the selection and booking of the drive. A “%” sign can be recognized in front of the top-listed business of the two businesses, which has the purpose of alerting the passenger to the fact that the businesses (partner firms of the operator of the booking system) in Metzingen offer a discount or other action to the participants of the drive. In contrast, the businesses in Ingolstadt do not offer such a discount.

The billing of the trip expenses for the driver and the front seat passenger takes place by way of the booking system.

Furthermore, details concerning the planned drive can be invoked by the booking system and/or can be communicated by way of a “social community” portal, such as Facebook (“f”). The former is illustrated as an example in FIG. 6. Here, the provider announces details concerning the drive (video screen 60). Also, a link (if existing) occurs here to the provider's or passengers' Facebook profile, so that personal information can be obtained concerning providers and passengers.

In addition to the above-described basic approach, additional alternatives and modifications of the process described in the following are contemplated:

A buyer can ask to be notified when drives in a certain category are newly offered and/or are no longer available. This can particularly take place by way of mobile terminals. In this case, a buyer can, for example, ask that it be indicated to him which drives have just started in his proximity and book into a drive at short notice (“spontaneous boarding”).

The mobility provider provides the users (driver and front seat passenger) with a method of securely registering and billing. This can, for example, take place by use of a hardware token which is used when boarding a drive as well as for the immediate debiting of the traveling expenses.

In this process, the mobility provider also provides a bonus and evaluation system. In this case, the passenger and the driver can be evaluated after the drive by way of the booking system.

Likewise, it is contemplated to obtain so-called badges, such as “Driver of the Month”, “Front Seat Passenger of the Month for Driving to the Home Improvement Center”, etc. A system of incentives is thereby created that has the purpose of animating the driver and the front seat passenger to carry out joint drives.

For each drive, points are credited to drivers and front seat passengers, which can be exchanged for bonuses. The points can be determined by the booking system, for example, in a graduated manner according to the distance (in kilometers or miles) driven and/or the number of passengers. The bonuses can be used, for example, for free drives for the driver, for driver training, or for the clearing for a higher vehicle class.

The mobility provider preferably also provides a process in the booking system by which users can discuss drives (online forum) and can further develop the mobility service on their own. The user may, for example, be permitted to make suggestions for new categories or also to make other vehicles available.

The mobility provider provides partner firms with a process for offering service features. The partner firm can register in a certain category and can offer to the mobility provider, for example, a discount on their merchandise if four members of the mobility service came in one car. The partner firm can also solicit in this category in the booking system. It is also contemplated to link to a website of the partner firm from the category, which website contains suggestions for driving destinations (for example, popular hiking destinations with beautiful excursion restaurants). Furthermore, an accounting system can be provided for the accounting of commissions, which the mobility provider receives for the procurement.

The process has the following advantages:

(1) Instead of the classic car sharing or the classic car pooling center or the classic event/leisure exchange, a combination of two is provided.

(2) Drives are not only offered between two locations (as is customary in the case of carpooling centers) but are additionally or exclusively offered in various categories. By way of the category selection, the booking system can also be used as an event exchange.

(3) The settlement of accounts for the driver and the front seat passenger takes place directly with the mobility provider. In comparison to a drive alone, the driver and the front seat passenger are charged a reduced price.

(4) Car sharing can therefore also be used by persons without a driver's license.

(5) The users may become acquainted with persons in their neighborhood with similar drive destinations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for computer-aided operation of a mobility service by which a number of vehicles are made available by a mobility provider to registered users for temporary use, the process comprising the acts of:
acquiring and storing registration data of a respective user once in a booking system, the respective user being registered as at least one of a provider of a mobility service feature and as a buyer of a mobility service feature;
booking a vehicle by reserving a vehicle in the booking system for a period of time based on a user input of a first user registered as a provider of a mobility service feature, wherein the user input comprises a time period and a desired vehicle;
clearing use of the mobility service feature for a second user that connects with the vehicle booking as a function of a further user input of the first user, wherein in the booking system the mobility service feature is offerable for selection by a second user via user interfaces; and
accounting for costs in providing the vehicle in the time period with respect to the first user as a function of whether, by way of the booking system, at least one second user was determined as a buyer of the provided mobility service feature, wherein the costs for the first user decrease as a function of the number of second users buying the provided mobility service feature.

2. The process according to claim 1, wherein a selection of the mobility service feature by the second user is carried out such that, based on a user input, one or more activity categories are selected to which the mobility service feature applies.

3. The process according to claim 2, wherein a classification of the mobility service feature into the one or more activity categories is carried out by the first user in that, based on a user input, one or more predefined and/or self-established activity categories are assigned to the mobility service feature.

4. The process according to claim 1, wherein the act of accounting for the costs further comprises the act of:
charging for the costs of the vehicle in the time period with respect to the second user as a function of whether at least one additional second user was determined as a buyer of the provided mobility service feature via the booking system based upon an initiative of the second user, the costs decreasing for the first user and the second user as a function of the number of additional second users buying the mobility service feature.

5. The process according to claim 1, further comprising the act of:
generating a message in an automated manner by the booking system and transmitting the message to a drive destination of the mobility service feature, the message containing information concerning the number of users registered for the mobility service feature.

6. The process according to claim 5, further comprising the act of:
generating, by the drive destination of the mobility service feature, a message in an automated manner in response to a mobility service feature offered by the first user and transmitting the message to the booking system, said message containing a bonus offer to buyers and potential users of the mobility service feature, the bonus offer being offered optionally as a function of the number of registered users.

7. The process according to claim 1, further comprising the act of:
crediting a point value to the providers and/or buyers of a mobility service feature for each use of the mobility service feature as a function of a number and/or type of the mobility service feature and/or a number of buyers, the point value being credited to respective user accounts.

8. The process according to claim 1, wherein of more than one first user, a respective first user having most frequently provided one or more mobility service features within a predefined time period is represented via the user interfaces.

9. The process according to claim 1, further comprising the act of:
entering a drive destination for a mobility service feature into the booking system based on a user input of a third party by way of a user interface.

10. The process according to claim 1, further comprising the act of:
automatically generating, via the booking system, a message and transmitting the message to a user interface of the second user, said message comprising information concerning an offered and/or a no longer available mobility service feature, if notification information for the second user is stored in the booking system.

11. The process according to claim 1, further comprising the acts of:
during the registering act of the user, receiving at least one of biometric data and one-to-one security information of the user; and
wherein during a boarding of the vehicle, the at least one of the biometric data and/or one-to-one security information of the user is verified.

12. A computer implemented booking system for a mobility service by which a number of vehicles are made available by a mobility provider to registered users for temporary use, the booking system comprising:
a processor operatively configured to:
acquire and store registration data of a respective user once in a booking system, the respective user being registered as at least one of a provider of a mobility service feature and as a buyer of a mobility service feature;
book a vehicle by reserving a vehicle in the booking system for a period of time based on a user input of a first user registered as a provider of a mobility service feature, wherein the user input comprises a time period and a desired vehicle;
clear use of the mobility service feature for a second user that connects with the vehicle booking as a function of a further user input of the first user, wherein in the booking system the mobility service feature is offerable for selection by a second user via user interfaces; and
account for costs in providing the vehicle in the time period with respect to the first user as a function of whether, by way of the booking system, at least one second user was determined as a buyer of the provided mobility service feature, wherein the costs for the first user decrease as a function of the number of second users buying the provided mobility service feature.

13. A method of operating a mobility service by which a number of vehicles are made available by a mobility provider to registered users for temporary use, the method comprising the acts of:
receiving, in the booking system, registration information on a respective user, the registration information being indicative of whether the respective user is a provider of a mobility service feature and/or is a buyer of a mobility service feature;
receiving, in the booking system, a user input of a first user that is registered as a provider of a mobility service feature, the user input comprising a time period and a desired vehicle in order to create a vehicle booking;
receiving, in the booking system, a further user input of the first user indicating that the mobility service feature is usable by one or more second users of the booking system;
outputting, via the booking system, an indication to second users that the mobility service feature is available for selection; and
determining, in the booking system, costs for providing the vehicle in the time period for the first user as a function of whether at least one second user selected the mobility service feature, the determining being such that the costs for the first user decrease as a function of the number of second users that select the mobility service feature.
